(19) United States
(12) Patent Application Publication
(10) Pub. No.: US 2007/0260043 A1
(43) Pub. Date: Nov. 8, 2007

(54) Method for Producing a Low Reducing Agent-Containing Keratin and Products Thereof

(75) Inventors: Theodorus Arnoldus Gerardus Floris, Arnhem (NL); Karel Joseph Slangen, Ede (NL)

Correspondence Address: OLIFF & BERRIDGE, PLC, P.O. BOX 19928, ALEXANDRIA, VA, 22320, US

(73) Assignee: TEIJIN TWARON B.V., ARNHEM (NL)

(21) Appl. No.: 11/791,739

(22) PCT Filed: Nov. 26, 2005
(86) PCT No.: PCT/EP05/12659

§ 371 Date: May 29, 2007

(30) Foreign Application Priority Data
Dec. 1, 2004 (EP) 04028419.2

(51) Int. Cl. C08H 1/06; C08L 89/04

(52) U.S. Cl. 530/357

(57) ABSTRACT

The invention pertains to a method for producing a low reducing agent-containing keratin, comprises the steps of (a) cleaving disulfide (CysS-SCys) bonds in a keratin-containing starting material, using a reducing agent in an aqueous medium, to obtain an intermediate keratin product wherein at least 90% of cleaved disulfide bonds have the structure CysS″ or CysSH; (b) removing excess of reducing agent at a pH between 9 and 14 to obtain an aqueous solution or dispersion of keratin having a ratio R of at least 10%, wherein R=100*([CysS″]+[CysSH])/([CysS″]+[CysSH]+2[CysS-SCys]); and (c) optionally, removing water to obtain a keratin-containing dispersion, powder, or granule. The invention further relates to products such as aqueous solutions, dispersions, powders, granulates, and the use of the keratin obtained in the 15 preparation of foam, shaped articles, and formulations.

The present invention relates to a method for producing a low reducing agent-containing keratin, to an aqueous solution, dispersions, powder or granulate containing the same, and to the use thereof for manufacturing foam, shaped articles, and formulations.

Feathers are an important waste product of the poultry industry, with about 4million tons being produced per year world-wide. Although minor amounts thereof find use in clothing, insulation, and bedding, and larger amounts in the preparation of feather meal for the production of animal feed, there are currently insufficient economically interesting applications for such large quantities of feathers. For environmental reasons burning or burying feathers is not always possible; and large amounts of waste feathers without economic application form a serious disposal problem for industries such as the poultry industry.

Thus, it is a general object of the invention to provide a range of economically viable uses of waste feathers, as well as to provide processes for making waste feathers suitable for such uses. This object was met in WO 03/006531, wherein a process was disclosed for obtaining improved keratin-based products by a process which involves a combination of partial hydrolysis of the keratin molecules and partial modification of obtained free CysSH groups. This partially hydrolyzed and partially modified product is dispersible in water and can be used in a range of applications. The process of partially modifying the obtained free CysSH groups is necessary to prevent cross-linking of the keratin during the process of removing reducing agent. Such pre-mature cross-linking, which is irreversible under the conditions used, disturbs the further use of the keratin. On the other hand if the keratin is fully modified it is no longer able to cross-link, and has therefore lost further commercial use. If no modification step is applied, the keratin will cross-link during the process of removing reducing agent, such as during dialysis or filtration and will then settle as an insoluble lump of product that cannot be used either. Partial modification thus requires a delicate balance between preventing pre-mature cross-linking on the one hand, and preventing inactivation on the other hand. Modification of keratin, moreover, is disadvantageous because it seriously adds to the costs because of the extra process step of modification and the step of removing excess of modification agent.

Thus, there is a considerable need for an economically viable method for making soluble or dispersible and active keratin-containing materials for use in solutions, dispersions, powders, granules, and the like.

It has now been found that unmodified keratin can easily and completely be freed from reducing agent without the occurrence of disturbing pre-mature cross-linking, when the removal step, such as a dialysis or filtration step, is performed at a specific pH range. This is a very remarkable finding, because until now it was believed that unmodified keratin cannot be separated from reducing agent under keeping it soluble or dispersible. Keratins that are modified to such low extent that the modification does not contribute to the purification of the keratin, for instance keratins for which less than 10% of free CysS⁻and/or CysSH groups are modified, are encompassed in the scope of the present invention.

Thus, in a first aspect, the invention relates to a process for producing a low reducing agent-containing keratin, comprises the steps of
(a) cleaving disulfide bonds in a keratin-containing starting material, using a reducing agent in an aqueous medium, to obtain an intermediate keratin product wherein at least 90% of cleaved disulfide bonds have the structure CysS⁻or CysSH;
(b) removing excess of reducing agent at a pH between 9 and 14 to obtain an aqueous solution or dispersion of keratin having a ratio R of at least 10%, wherein R=100*([CysS⁻]+[CysSH])/([CysS⁻]+[CysSH]+2[CysS-SCys]); and
(c) optionally, removing water to obtain a keratin-containing dispersion, powder, or granule.

In U.S. Pat. No. 4135942, example 1 feather extracts are treated at pH 11 with reducing agent (sodium thioglycolate) and after centrifuging the supernatant was dialyzed against distilled water. This means that the excess of reducing agent is removed at pH 7 (distilled water) rather than pH 9-14, which is the pH range of this invention. The keratin obtained therefore is not free keratin, but is coagulated to dimeric and polymeric material, forming a gel-like structure. Such keratin thus does not satisfy the requirement that R is at least 10%.

For the same reason Schrooyen et al., J. Agric. Food Chem., 48, 4326-4334) do not disclose free keratin, but coagulated dimeric and polymeric material, forming a gel-like structure wherein the requirement that R is at least 10% is not satisfied.

The critical feature of the invention is the pH conditions that are necessary for removing excess of reducing agent to obtain low reducing agent-containing keratin without disturbing pre-mature cross-linking the keratin and therefore maintaining its reactivity. The term “low reducing agent-containing keratin ” as used in this invention means keratin containing less than 10⁻² mole, preferably less than 10⁻³ mole, most preferably less than 10⁻⁴ mole, of reducing agent per gram keratin.

For the keratin-containing starting material any suitable source of keratin may be used. In particular, natural sources of keratin fibers may be used, such as hair, feathers, wool, hoofs, nails, horns and the like. Preferably, a source of keratin containing at least β-keratin is used. Feathers are an especially preferred starting material, in particular feathers of chicken, turkey, ducks, geese, or any other poultry, e.g. as obtained as waste product from the poultry industry. These sources of keratin may contain minor amounts of other proteins and/or other components such as fat or blood, e.g. usually amounts of less than 5% of the total weight (based on dry materials, for instance feathers). Generally, the presence of other components may be tolerated, otherwise, some or all of these non-keratin components may be removed, prior to step (a). The keratin-containing starting material is preferably subjected to one or more pretreatments such as e.g. cleaning, washing, sorting, defatting, cutting, milling, grinding, drying, or any combination thereof. Such pretreatment may facilitate the handling of the starting material, it may improve the efficiency of further processing steps, such as cleavage of the keratin, and/or it may improve the quality of the final keratin-based product. Alternatively, an already pre-processed keratin-containing starting material may be used, such as feather meal; as well as already isolated keratins or keratin fibers. It is also encompassed in the scope of the invention to use a natural source of keratin or keratin fibers, e.g. feathers, directly in step (a), without any further pre-treatment.

The reducing agent may be chosen from any suitable reducing agent known in the art such as sulfides, thiols, boric hydride and phosphines, or combinations thereof. Preferred sulfides are alkali metal sulfides, such as sodium sulfide, and ammonium sulfide. Removal of excess reducing agent is required since reducing agents are usually toxic and bad smelling substances, such as 2-mercaptoethanol or dithiothreitol.

The conditions of reduction, i.e. the concentrations of the keratin-containing starting material, the reducing agent(s), and buffer, and the pH, temperature and duration are preferably chosen such that a satisfactory yield of keratins is obtained, wherein preferably at least 10%, preferably at least 20%, most preferably at least 40% of CysS-SCys bonds is cleaved (i.e., cleavage of the inter-and intramolecular disulfide groups in keratin, usually by reduction). The conditions of cleaving are further preferably chosen such as specified herein below.

The concentration of the reducing agent in the aqueous medium, e.g. of an alkali metal sulfide or ammonium sulfide, is preferably between 0.05 M and 1.0 M. The pH at which the keratins are cleaved is alkaline, i.e. higher than pH 7, and preferably not higher than 14.

Preferably, however, cleavage is performed at an alkaline pH that is at least pH 8, preferably at least 9, and most preferably at least 10, because at a pH of at least 10 the dissociation equilibrium of sulfide shifts towards S²⁻, which is a stronger reductor than HS⁻.

The temperature at which the keratins are reduced is preferably at least 20° C. However, preferably higher temperatures are used for cleavage, such as a temperature of preferably at least 30° C., more preferably about 50 to 80° C. but preferably not higher than 100° C.

The duration of the keratin cleavage step is primarily chosen such that under the given cleavage conditions, the desired degree of cleavage of disulfide is obtained. Typically the cleavage will take between 10 minutes and 24 hours.

Thus the skilled person will empirically optimize the set of conditions for keratin cleavage in order to obtain at least the desired degree of keratin disulfide cleavage.

In the process of the invention the keratin is preferably not modified. Thus of the keratin preferably at least 90%, more preferably at least 95%, most preferably at least 99%, and best 100% of the cleaved disulfide bonds have the structure CysSH or CysS^{—}.

The keratin amide bonds may be hydrolyzed to a certain degree, such that a keratin-based product produced from the cleaved and partially hydrolyzed keratin has the required physical and chemical properties. Hydrolysis means cleavage of peptide bonds in the keratin molecule. Thus, the distribution of the molecular weights of the cleaved and partially hydrolyzed keratin may be defined as follows. The cleaved and optionally partially hydrolyzed keratin preferably has essentially a molecular weight of between 1 and 11 kDa, and in particular between 3 and 10.4 kDa, whereby essentially is understood to mean that at least 50%, preferably at least 90%, more preferably at least 95%, and most preferably at least 99% of the keratin molecules present in the partially hydrolyzed keratin fraction have a molecular weight within the indicated range (molecular weight as determined in WO 03/006531).

The intermediate keratin product thus obtained must be freed from as much as possible reducing agent, often sulfide ions originating from the reduction agent. To this end the mixture is subjected to a removal step, such as precipitation and centrifugation, or dialysis or filtration such as ultrafiltration or nanofiltration, to separate the keratin from the reducing agent, as to obtain keratin preferably containing less than 10⁻² mole of reducing agent per gram of keratin. Preferably, the keratin contains per gram of keratin less than 10⁻³ mole of reducing agent, most preferably less than 10⁻⁴ mole of reducing agent, and if possible is completely free of reducing agent.

It is essential that this removal step, particularly the dialysis or filtration step, is performed within a narrow pH range of 9 to 14, preferably between 10 and 13, and most preferably between 10 and 12.5.

Dialysis methods are methods such as described in the handbook of C.M. Mohr et al.; Membrane applications and research in food processing; Noyes Data Corporation, New Jersey, USA.

Filtration methods include nano- and ultrafiltration, such as described in the handbook of C. M. Mohr et al.; Membrane applications and research in food processing; Noyes Data Corporation, New Jersey, USA.

The keratin thus obtained is soluble or dispersible and reactive. Thus the keratin can be obtained in an aqueous solution or dispersion. At the same time the keratin is still active, containing free CysSH and/or CysS⁻groups, allowing the keratin to cross-link if required. This reactivity is expressed as the ratio R, wherein R stands for the quotient 100*([CysS³¹ ]+[CysSH])/([CysS³¹ ]+[CysSH]+2[CysS-SCys]). R is at least 10%, preferably at least 20%, and most preferably at least 40 %.

In an optional aspect of the invention, the cleaved keratin may be subjected to further processing steps, which may include modification, cross-linking, further purification, e.g. to remove undesired components and/or substances from the keratin product obtained. These may for instance include remaining keratin starting material, higher molecular weight keratin components, lower molecular weight keratin components, reactants and/or by-products from any of the process steps, and/or other impurities or undesired components. Suitable techniques for removing such components or substances include e.g., washing, precipitation, dialysis, filtration, and centrifugation.

Also, depending upon the intended use, the keratin product may be combined or mixed with one or more further substances, additives, components, etc. Some non-limiting examples thereof include pigments, salts, anti-microbial agents, detergents, and plasticizers.

It will be clear that any such further processing and/or addition of further components may also be carried out by the end-user; and this is also encompassed within the scope of the invention.

The compositions according to the invention will often be in the form of an aqueous solution or dispersion of the keratins. Such solutions or dispersions will preferably contain at least 10 g of keratin per liter, and preferably more than 50 g of keratin per liter. Generally such solution or dispersions will contain about 100 g of keratin per liter or more. These solutions and dispersions are stable in both chemical and physical senses. Thus, in chemical sense, no disturbing (further) cross-linking occurs over the storage period. In order to stabilize the solutions or dispersions of the invention, additives known in the art may be applied. For longer-term storage or for more convenient transportation, the compositions of the invention may be in a solid form, preferably in the form of a dispersible powder or granulate. The usual techniques for drying and/or granulating may be applied, including the use of additives to aid in the formulation of the solid form.

A further aspect of the invention relates to a process for producing a keratin-based product using the low reducing agent-containing keratins of the invention as source of keratin. Preferred keratin-based products are produced by casting a solution or dispersion of the low reducing agent-containing keratin of the invention.

In a preferred embodiment, the keratin-based product is a film or a coating casted from a solution or dispersion of the low reducing agent-containing keratin of the inventions. The keratin-based product may also be used for making a foam or used in a spin dope for spinning fibers.

The keratins of the invention may be used in any application for keratin-based products known in the art, including those applications mentioned in the prior art given hereinabove. Generally, in these applications, the keratin-derived products of the invention will provide favorable properties including but not limited to improved mechanical properties such as mechanical stability; improved physical and chemical stability; and good film-forming properties. Thus, some non-limiting uses of the keratins of the invention include their use in films, fibers, coatings, etc., or in the preparation thereof; use in (biodegradable) packaging materials, or in the production thereof; use in formulations such as controlled release systems, e.g. for active substances such as pharmaceuticals; agrochemicals such as herbicides, pesticides or other biocides; flavorings; perfumes; etc.; use in the formation of emulsions, dispersions or other multi-phase systems; use in fillers, gelatin agents, binders, bulking agents, granulating agents, release agents, matrix materials, emulsifiers, stabilizers or other formulating agents; use as anti-oxidants; use as anti-microbial agents, and the like.

As such, the keratins of the invention may for example find use in food products or in the field of food technology generally; in pharmaceutical and veterinary products; in cosmetics; in the field of agrochemicals; in adhesives; in paints or other coatings; in packaging materials; in cleansing agents such as detergents; in agriculture. Some specific uses of the keratins of the invention that are envisaged include, but are not limited to use as coatings or binders for granules, powders etc. such as washing powder or other detergents; use in general purpose adhesives, both for industrial as well as household use; use as binder or adhesive for wood, paper, paperboard or molded fiber; use as binders in coatings, including but not limited to water-borne paint systems and/or ink systems; both for industrial as well as household use; use as anti-oxidant; use in encapsulating and/or coating technology; use as anti-microbial agents in for instance animal feed and cosmetics.

The invention is further illustrated by the following figures and examples.

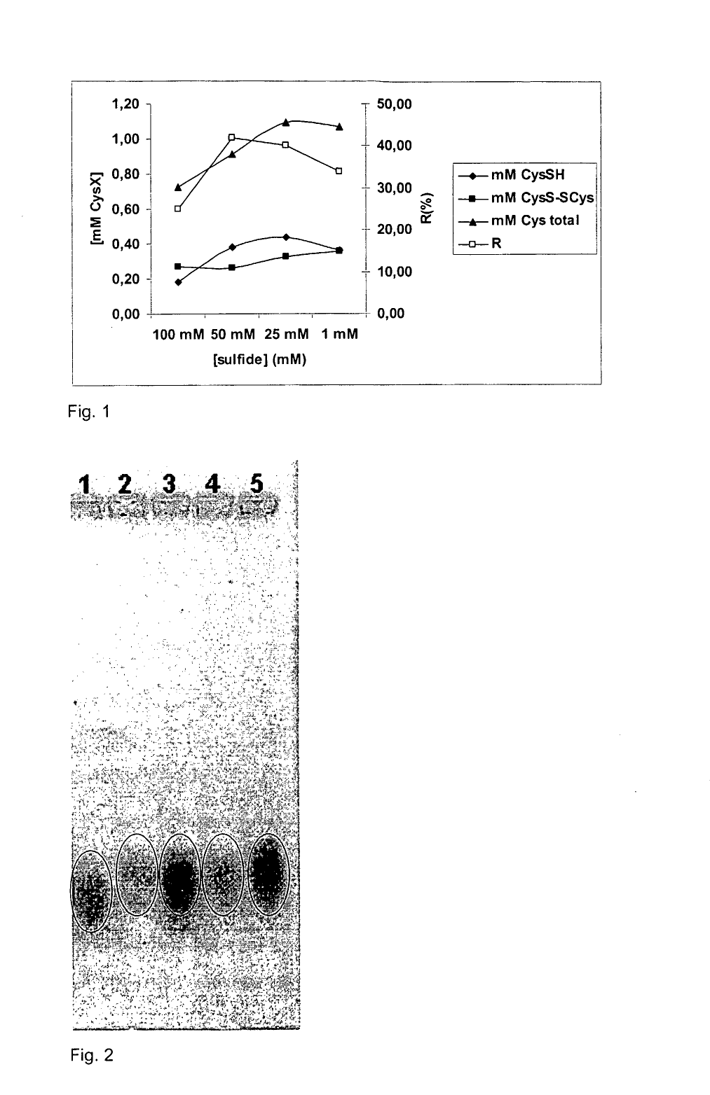

FIG. 1 shows the reactivity of keratins

FIG. 2 shows the SDS-agarose properties of keratin samples.

In FIG. 1 the results of the determination of the reactivity of keratins-during the diafiltration process are given. At various stages during the diafiltration process (which correlates with various free sulfide-levels) samples were taken and the level of CysS-SCys bridges and free CysSH groups in the keratins were determined. The R value (using the formula R=100*([CysS⁻]+[CysSH])/([CysS⁻]+[CysSH]+2[CysS-SCys]) is also shown at the various stages during diafiltration. The figure shows that the levels of free cysteines and of CysS-SCys disulfide bridges do not vary much during diafiltration, which means that keratin reactivity is maintained during this process.

In FIG. 2 the SDS-agarose gel of keratin samples at different stages during the dissolution process and subsequent diafiltration process is shown. 1: keratins after dissolution of chicken feathers (100 mM sulfide); 2: keratins (1) after dialysis against water pH 10; 3: keratins after diafiltration at 50 mM sulfide; 4: keratins after diafiltration at 25 mM sulfide; 5: keratins after diafiltration at 1 mM sulfide.

### EXAMPLE 1

Chicken feathers (40 g/l) were dissolved in 100 mM Na₂S for 1 hour at 60° C. at pH 11.5. After this dissolution process the keratin mixture was ultra-filtrated using membranes with a cut-off value of 5 kDa. During the ultra-filtration process the keratin-solution was diafiltrated using water of pH 10-11. At various points during the ultra-filtration process samples were taken for determining the reactivity of the keratins. This was done by determining the amount of CysS-SCys bridges and the amount of free CysSH groups (FIG. 1).

The content of CysS-SCys bridges was measured using the NTSB-assay and the content of CysSH groups was determined using the DTNB (Ellman's reagens) assay, as described in P. Schrooyen, Feather keratins; modification and film formation, thesis University of Twente (1999), page 29. This example shows that the reactivity of the keratins remains constant during the diafiltration process and thus no loss of activity occurs.

### EXAMPLE 2

The early cross-linking of keratins during the processes of dissolution and diafiltration should be prevented. Therefore, chicken feathers (40 g/l) were dissolved in 100 mM Na₂S for 1 hour at 60° C. at pH 11.5. After this dissolution process the keratin mixture was ultra-filtrated using membranes with a cut-off value of 5 kDa. During the ultra-filtration process the keratin solution was diafiltrated using water of pH 10-11 using a ultra-filtration membrane with a cut-off value of 5 kDa. At various time points keratin samples were taken and the cross-linking (occurrence of large covalent aggregates) was measured using the SDS-agarose gel electrophoresis technique as described by A. C. Alting et al., J. Agric. Food Chem., 48, 5001-5007 (2000). In FIG. 2 the results are shown of this experiment.

From these results it can be concluded that during the diafiltration process no significant cross-linking occurs.

### EXAMPLE 3

Chicken feathers (420 gram) were dissolved in 100 mM Na₂S at 60° C., pH 11.5 in a volume of 10.5 liter. After 1 hour of dissolution the keratin mixture was diafiltrated (700%) with an ultra-filtration membrane (with a cut-off value of 2 kDa) using water at pH 11.5 for the removal of excess sulfide. The diafiltrated keratin solution was concentrated to a volume of 3 liter (7.6% keratin w/w). This final keratin concentrated solution was subsequently freeze-dried and 219 gram of dry keratin powder was obtained.

1. A method for producing a low reducing agent-containing keratin, comprising:
(a) cleaving disulfide bonds in a keratin-containing starting material, using a reducing agent in an aqueous medium, to obtain an intermediate keratin product wherein at least 90% of cleaved disulfide bonds have the structure CysS⁻or CysSH;
(b) removing excess of the reducing agent at a pH between 9 and 14 to obtain an aqueous solution or dispersion of keratin having a ratio R of at least 10%, wherein R=100*([CysS³¹ ]+[CysSH])/([CysS⁻]+[CysSH]+2[CysS-SCys]); and
(c) optionally, removing water to obtain a keratin-containing dispersion, powder, or granule.

2. The method according to claim 1 wherein (b) is performed at a pH between 10 and 13.

3. The method according to claim 1 wherein the reducing agent comprises an inorganic base and a sulfide selected from a metal sulfide and ammonium sulfide.

4. The method according to claim 1 wherein the inorganic base is selected from a hydroxide, a carbonate and a hydrogen carbonate of sodium, potassium, or ammonium.

5. The method according to claim 4 wherein the inorganic base is sodium hydroxide.

6. The method according to claim 3 wherein the sulfide is ammonium sulfide or an alkali metal sulfide.

7. The method according to claim 1 wherein the excess of the reducing agent is removed by dialysis or filtration.

8. An aqueous solution or dispersion comprising at least 10 g/l keratin, or a solid powder or granulate comprising keratin, the keratin having a ratio R of at least 10%, wherein R=100*([CysS⁻]+[CysSH])/([CysS⁻]+[CysSH]+2[CysS-SCys]) and containing less than 10-2 mole of reducing agent per gram keratin.

9. (canceled)

10. (canceled)

11. The method according to claim 1 wherein (b) is performed at a pH between 10 and 12.5.

12. The method according to claim 6 wherein the alkali metal sulfide is sodium sulfide.

13. The method according to claim 7 wherein the excess of the reducing agent is removed by ultrafiltration.

14. A method for making a material selected from the group consisting of foam, films, coatings, biodegradable packaging materials, fibers, formulations for controlled release systems for active substances, emulsions, dispersions or multi-phase aqueous systems, fillers, gelling agents, binders, bulking agents, granulating agents, release agents, matrix materials, emulsifiers, stabilizers, anti-oxidants and anti-microbial agents, comprising preparing the material from the aqueous solution or dispersion comprising keratin, or the solid powder or granulate comprising keratin, of claim 8.

15. A method for making pure unmodified keratin, comprising producing the pure unmodified keratin so as to be free of reducing agent according to the method of claim 1.
